(19) United States
(12) Patent Application Publication
(10) Pub. No.: US 2010/0235530 A1
(43) Pub. Date: Sep. 16, 2010

(54) CONTROL METHOD OF TRANSMITTING STREAMING AUDIO/VIDEO DATA AND ARCHITECTURE THEREOF

(75) Inventors: Ching-Yao HUANG, Hsinchu (TW); Zhi-Zhan CHEN, Hsinchu (TW); Chun-Hsiao LI, Hsinchu (TW)

Correspondence Address: Muncy, Geissler, Olds & Lowe, PLLC, 4000 Legato Road, Suite 310, FAIRFAX, VA, 22033, US

(73) Assignee: NATIONAL CHIAO TUNG UNIVERSITY, Hsinchu (TW)

(21) Appl. No.: 12/703,292

(22) Filed: Feb. 10, 2010

(30) Foreign Application Priority Data
Feb. 11, 2009 (TW) 098104304

(51) Int. Cl. G06F 15/16

(52) U.S. Cl. 709/231; 709/233

(57) ABSTRACT

A control method and architecture for controlling transmission of streaming audio/video data are disclosed. The method uses a report transmission rate on a transmitter to reduce the playback latency on a receiver. The report transmission rate is determined according to an actual transmission rate and the residual data amount of the previous period of a transmitter buffer. The actual transmission rate is the minimum of an available transmission rate and a required transmission rate, which depends on the residual data amount and the report transmission rate. Therefore, the report transmission rate is adjusted according to the accumulation of residual data of transmitter buffer, which improves the playback latency.

### BACKGROUND OF THE INVENTION

1. Field of the Invention

The present invention relates to a control method of transmitting streaming audio/video data and architecture thereof, and more particularly to a control method and architectures of transmitting streaming audio/video data with low playback latency.

2. Description of the Related Art

On a transmitter, streaming audio/video data are often encoded and extracted. Extracted streaming audio/video data are input to a transmitter buffer at an input rate, and transmitted to a receiver buffer of a receiver at a transmission rate. On the receiver, an earlier input rate on the transmitter is used as a playback rate, at which the receiver buffer outputs its data.

When the transmission rate is smaller than the input rate, some data can not reach the receiver buffer in time, causing playback latency; on the other hand, when the transmission rate is larger than the input rate, and an available transmission rate between the transmitter and receiver is still larger than the transmission rate, part of the bandwidth is wasted.

The following example illustrates a disadvantage of a prior art architecture for transmitting streaming audio/video data. The prior art architecture is illustrated in FIG. 1. An extraction module 102 extracts streaming audio/video data from an audio/video data source, and transmits streaming audio/video data to a transmitter buffer B_{T} at an estimated transmission rate rₑₛₜ (denoted by arrow frame 104). The transmitter buffer B_{T} outputs its data at an actual transmission rate r_{act} to a receiver buffer B_{R} (denoted by arrow frame 106). A transmission amount control module 110 determines an estimated transmission rate rₑₛₜ based on the actual transmission rate (denoted by an arrow sending r′_{act}), and the estimated transmission rate rₑₛₜ is reported to the extraction module 102 (denoted by an arrow sending rₑₛₜ). On the receiver, data in the receiver buffer B_{R} is output at a playback rate (denoted by arrow frame 108).

The estimated transmission rate rₑₛₜ and the actual transmission rate r_{act} are often different. Therefore, a portion of data are temporarily held in the transmitter buffer B_{T}; however, later on, data are still taken out from the receiver buffer B_{R} at the estimated transmission rate rₑₛₜ of the transmitter. Playback latency occurs when there are no data in the receiver buffer B_{R} as illustrated in the following example.

In FIG. 2, a dashed line divides a transmitter and a receiver, illustrated above and below the dashed line respectively. For a certain period t, an arrow frame above a transmitter buffer B_{T} represents inputting an input data amount to the transmitter buffer at an estimated transmission rate rₑₛₜ, and since in this example, the length of a period equals a second, the value of the input data amount in one period is equal to the value of the estimated transmission rate rₑₛₜ, which is the number inside the arrow frame. The length of the arrow is proportional to the speed of the transmission rate. For a certain period t, an arrow frame below a transmitter buffer B_{T} represents outputting an output data amount from the transmitter buffer B_{T} at an actual transmission rate r_{act}, and the number inside the arrow frame is equal to the value of the actual transmission rate r_{act} as well as the value of the output data amount. The length of the arrow is proportional to the speed of the actual transmission rate r_{act}. For a certain period, the shaded portion of the transmitter buffer B_{T} and the number above the shaded portion is the residual data amount of the transmitter buffer B_{T} after transmission. In this example, actual transmission rates r_{act} of several periods before the 8ₜₕ period (t=8) are smaller than the respective estimated transmission rates rₑₛₜ, and therefore, a portion of data are temporarily held in the transmitter buffer B_{T}, which is implied by the growth of the residual data amount of the transmitter buffer B_{T}. However, the receiver buffer B_{R} still uses earlier estimated transmission rates rₑₛₜ to output data. For this particular example, the receiver buffer B_{R} uses the estimated transmission rate rₑₛₜ of the transmitter two periods earlier as the playback rate r_{play}. As a result, in the 8ₜₕ period, the residual data amount of the receiver buffer B_{R} is 0 (kb), which means playback latency occurs.

Therefore, the present invention proposes to adopt a report transmission rate for inputting data to the transmitter buffer B_{T}, considering a residual data amount of the transmitter buffer B_{T}, so as to lower the occurrences of playback latency on the receiver.

### SUMMARY OF THE INVENTION

The present invention is directed to a control method of transmitting streaming audio/video data. A report transmission rate, based on an actual transmission rate with an adjustment from considering a residual data amount of the transmitter buffer, is determined. Streaming audio/video data are transmitted at the report transmission rate to lower the occurrences of playback latency on the receiver.

One embodiment discloses a control method of transmitting streaming audio/video data including: for every report period, determining a report transmission rate based on an actual transmission rate and a residual data amount of the previous period; for every period in a report period, inputting an input data amount at the report transmission rate to the transmitter buffer, and determining an actual transmission rate, at which data in the transmitter buffer are transmitted to the receiver. The actual transmission rate is determined by selecting the minimum between a required transmission rate and an available transmission rate, wherein the required transmission rate is calculated based on the residual data amount of the previous period and the report transmission rate.

One embodiment discloses an architecture for transmitting streaming audio/video data, for realizing aforementioned control method of transmitting streaming audio/video data. The architecture includes an extraction module, a transmitter buffer and a transmission amount control module. Transmission amount control module determines a report transmission rate based on an actual transmission rate and a residual data amount of the transmitter buffer and controls streaming audio/video data extraction module to extract streaming audio/video data from an audio/video data source and input streaming audio/video data to the transmitter buffer at the report transmission rate.

### BRIEF DESCRIPTION OF THE DRAWINGS

The objectives, technical contents and characteristics of the present invention can be more fully understood by reading the following detailed description of the preferred embodiments, with reference made to the accompanying drawings, wherein:

FIG. 1 is a schematic diagram illustrating a prior art architecture for transmitting streaming video/audio data;

FIG. 2 illustrates an example of playback latency of the prior art;

FIG. 3 is a flow chart of a control method of transmitting streaming video/audio data according to one embodiment of the present invention;

FIG. 4 is a flow chart for one step of the control method of transmitting streaming video/audio data according to one embodiment of the present invention;

FIG. 5 is a flow chart for one step of the control method of transmitting streaming video/audio data according to one embodiment of the present invention;

FIG. 6 illustrates an example of determining related variables of a transmitter buffer;

FIG. 7 illustrates an example of the playback latency improvement of the present invention;

FIG. 8 is a schematic diagram illustrating an architecture of transmitting streaming video/audio data according to one embodiment of the present invention;

FIG. 9a is a schematic diagram illustrating an architecture of transmitting streaming video/audio data according to one embodiment of the present invention; and

FIG. 9b is a schematic diagram illustrating an architecture of transmitting streaming video/audio data according to one embodiment of the present invention.

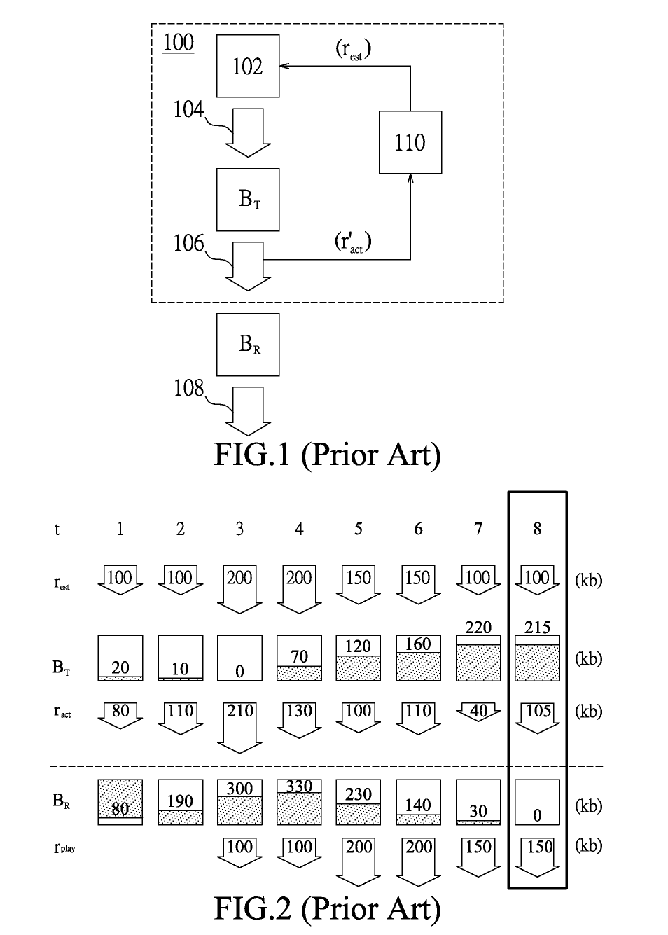

### DETAILED DESCRIPTION OF THE INVENTION

On a transmitter, streaming audio/video data are often encoded and extracted. Extracted streaming audio/video data are then input to a transmitter buffer at an input rate. Data in the transmitter buffer are output to a receiver buffer of a receiver at an actual transmission rate i.e. output rate of the transmitter. The receiver uses the input rate as the playback rate at which data in the receiver buffer are taken out. The input rate and the actual transmission rate are usually different. If the actual transmission rate is smaller than the input rate, a portion of data would be temporarily held in the transmitter buffer; however, since the input rate is still used to output data from the receiver buffer, and when there is no data in the receiver buffer, playback latency occurs. If the actual transmission rate is larger than the input rate, and an available transmission rate from the transmitter to the receiver is still larger than the actual transmission rate, part of the bandwidth is wasted.

One embodiment uses a report transmission rate as the input rate. It determines the report transmission rate based on the actual transmission rate and a residual data amount of the transmitter buffer to control the playback rate of the receiver and the residual data amount of the receiver buffer, and thus improves playback latency. The actual transmission rate is the minimum between a required transmission rate and an available transmission rate, wherein the required transmission rate is calculated based on the residual data amount of the transmitter buffer and the report transmission rate. The method for determining the report transmission rate and the actual transmission rate is explained as follows.

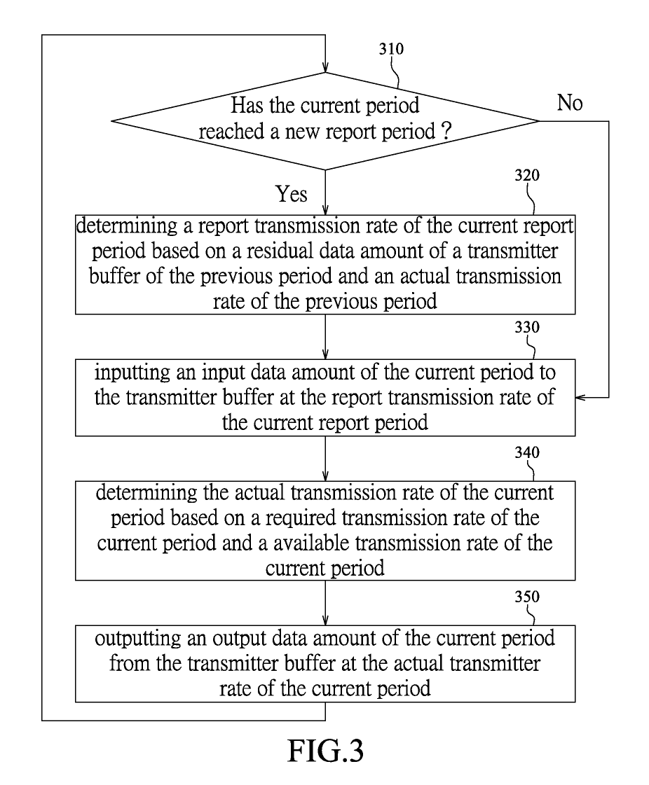

FIG. 3 is a flow chart of the control method of transmitting streaming audio/video data according to one embodiment, including: determining if the current period has reached a new report period (step 310), if so, calculating a report transmission rate rᵣₑₚ (step 320) based on an actual transmission rate r′_{act} and a residual data amount D′ᵣₑₛ of the previous period; if not, skip updating the report transmission rate rᵣₑₚ and then inputting an input data amount to the transmitter buffer at the report transmission rate rᵣₑₚ (step 330); and determining an actual transmission rate r_{act} (step 340), at which an output data amount is output from the transmitter buffer to the receiver (step 350), based on a required transmission rate r_{req} and an available transmission rate rₐᵥₗ.

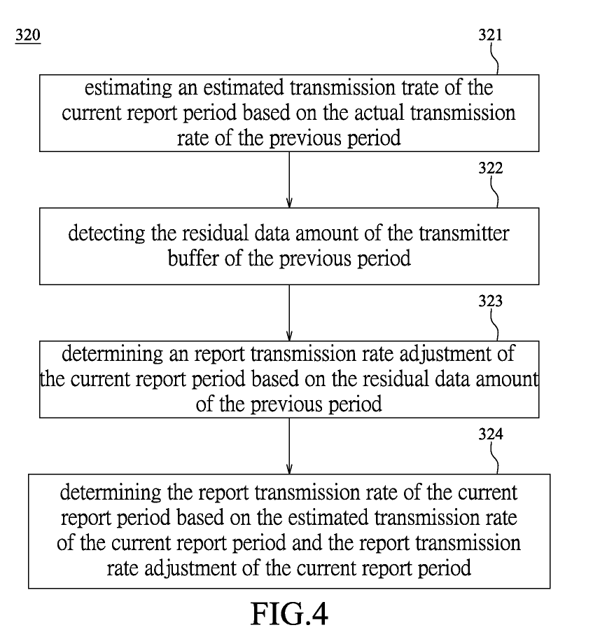

According to an embodiment, the steps for determining the report transmission rate rᵣₑₚ (step 320 in FIG. 3) are illustrated in FIG. 4. First, an estimated transmission rate rₑₛₜ is estimated according to the actual transmission rate r_{act} of the previous period (step 321). The residual data amount D′ᵣₑₛ of the previous period is detected (step 322). A report transmission rate adjustment Δ is calculated based on the residual data amount of the previous period D′ᵣₑₛ (step 323). Finally, the report transmission rate rᵣₑₚ is calculated based on the estimated transmission rate rₑₛₜ and the report transmission rate adjustment Δ (step 324). Please note that the report transmission rate adjustment Δ may adjust the estimated transmission rate rₑₛₜ up or down for the report transmission rate rᵣₑₚ.

Common methods for estimating estimated transmission rate rₑₛₜ (step 321) include mean, median, infinite impulse response (IIR) and instant mechanisms. The listed four methods estimating estimated transmission rate rₑₛₜ are for the purpose of providing examples rather than limiting the scope of the present invention.

The two embodiments using the report transmission rate adjustment Δ to adjust the estimated transmission rate rₑₛₜ for determining the report transmission rate rᵣₑₚ (step 324) can be represented by equations (1) and (2) respectively:

rᵣₑₚ=rₑₛₜ−αΔ (1)

rᵣₑₚ=α(rₑₛₜ−Δ) (2)

wherein α is an adjusting coefficient, which can be a fixed value or a dynamically adapted value, and it usually ranges from 0 to 1 (denoted as [0, 1]). The report transmission rate adjustment Δ can be calculated by equation (3) (step 323):

$$Δ = \frac{{D}_{res}^{′}}{T} \qquad ( 3 )$$

wherein T is a report period, which is not smaller than a period.

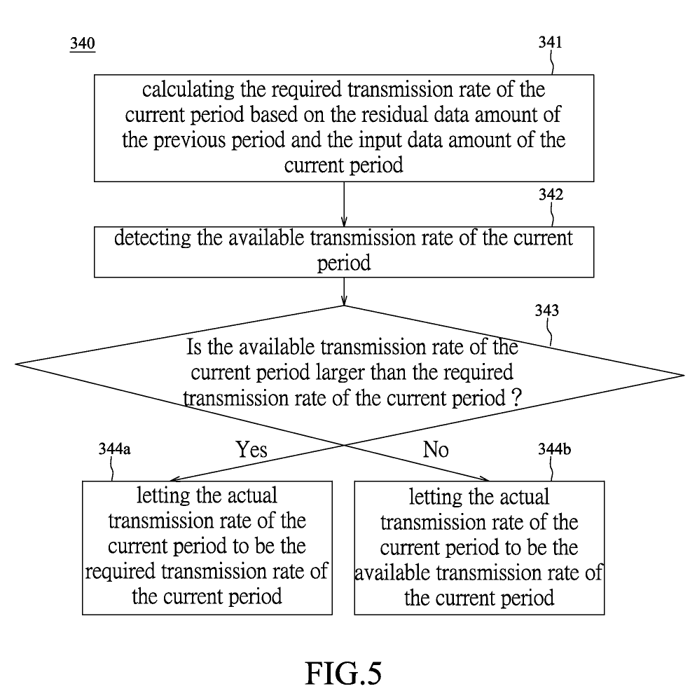

Steps for determining the actual transmission rate r_{act} (step 340 in FIG. 3) are illustrated in FIG. 5. First, a required transmission rate r_{req} calculated based on the residual data amount of the previous period D′ᵣₑₛ and the input data amount Dᵢₙ of the current period can be represented by equation (4):

$${r}_{req} = \frac{{D}_{res}^{′} + {D}_{in}}{t} \qquad ( 4 )$$

wherein t is a period. Then an available transmission rate rₐᵥₗ is detected (step 342) and compared with the required transmission rate r_{req} (step 343), and the minimum value of the two is selected to be the actual transmission rate r_{act} (344a or 344b).

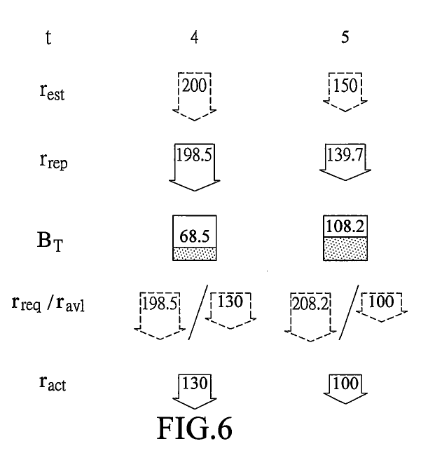

FIG. 6 illustrates an example of how the transmitter buffer B_{T} related variables are updated. The first row represents index of each period t. The number 4 and 5 refers to the 4ₜₕ period (previous period) and the 5ₜₕ period (current period). For the purpose of illustration, a period t is equal to one second, a report period T is equal to two seconds (duration of two periods), and the current period is assumed to have reached a new report period. Equation (1) is used to determine the report transmission rate rᵣₑₚ in this example, and row 2 in the figure is for the estimated transmission rate rₑₛₜ in equation (1). In row 2, the number in each dotted arrow frame is the value of the estimated transmission rate rₑₛₜ in a certain period, and it is equal to 150 (kb/s) for the current period. The length of each arrow refers to the speed of the estimated transmission rate rₑₛₜ in a certain period. The adjusting coefficient α in equation (1) is assumed to be 0.3 for the purpose of illustration, and the report transmission rate adjustment Δ can be calculated by equation (3), wherein the residual data amount of the previous period D′ᵣₑₛ is 68.5 (kb), and therefore, the report transmission rate adjustment Δ is 34.3 (kb/s) and the report transmission rate rᵣₑₚ is 139.7 (kb/s).

Next, in the current period, an input data amount Dᵢₙ is input to the transmitter buffer B_{T} at the report transmission rate rᵣₑₚ. Since a period is equal to a second in this example, the value of the input data amount Dᵢₙ is equal to that of the report transmission rate rᵣₑₚ, and this value is the number inside the solid arrow frame at the 5ₜₕ period. The length of the arrow refers to the speed of the report transmission rate rᵣₑₚ. The input data amount Dᵢₙ transmitted to the transmitter buffer B_{T} of the current period is 139.7 (kb).

Next, the actual transmission rate r_{act} is the minimum between a required transmission rate r_{req} and an available transmission rate rₐᵥₗ, which are represented by two dotted arrow frames next to each other in the current period in row 4 (row r_{req}/rₐᵥₗ), and the value of the required transmission rate r_{req} and the value of the available transmission rate rₐᵥₗ is equal to the number in the left dotted arrow frame and the number in the right dotted arrow frame respectively. The required transmission rate r_{req} can be calculated by equation (4), wherein the residual data amount of the previous period D′ᵣₑₛ and the input data amount Dᵢₙ of the current period are 68.5 (kb) and 139.7 (kb) respectively, and therefore, the required transmission rate r_{req} of the current period is 208.2 (kb/s). Since the available transmission rate rₐᵥₗ of the current period is 100 (kb/s) which is smaller than the required transmission rate r_{req}, the actual transmission rate r_{act} is equal to the available transmission rate rₐᵥₗ, which is equal to 100 (kb/s).

Finally, in the current period, an output data amount Dₒᵤₜ is output from the transmitter buffer B_{T} at the actual transmission rate r_{act}. Since a period is equal to a second in this example, the output data amount Dₒᵤₜ and the actual transmission rate r_{act} have the same value, which is the number inside the solid arrow frame in the current period in row 5 (row r_{act}). The length of the arrow refers to the speed of the actual transmission rate r_{act}.

The residual data amount Dᵣₑₛ of the transmitter buffer B_{T} of the current period is 108.2 (kb), which is calculated by equation (5):

Dᵣₑₛ=D′ᵣₑₛ+Dᵢₙ−Dₒᵤₜ (5)

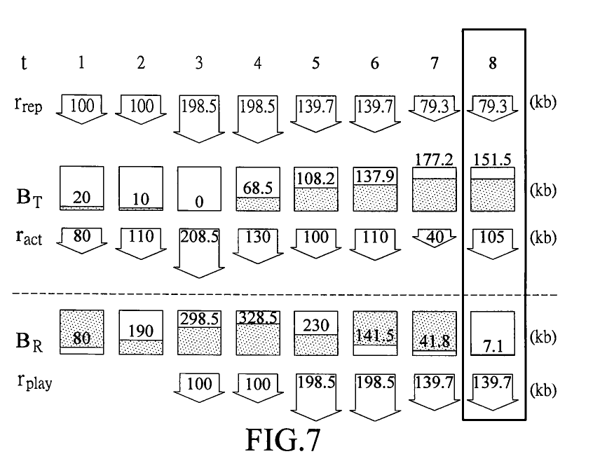

FIG. 7 illustrates an example of the playback latency improvement of the above embodiment. The dashed line divides a transmitter and a receiver, illustrated above and below the dashed line respectively. On the receiver, data in the receiver buffer B_{R} are output at a playback rate r_{play}, and since a period is equal to one second in this example, an output data amount of the receiver buffer B_{R} and a playback rate r_{play} in a period are of the same value, which is the number inside the arrow frame below the receiver buffer B_{R} in such period. On the transmitter, in a certain period, an input data amount Dᵢₙ is input to the transmitter buffer B_{T} at a report transmission rate rᵣₑₚ, and in this example, on the receiver, two periods later, the report transmission rate rᵣₑₚ is set as the playback rate r_{play} at which a data amount equal to the input data amount Dᵢₙ is output from the receiver buffer B_{R}. For example, in the 7ₜₕ period, the playback rate r_{play} of the receiver is set as the report transmission rate rᵣₑₚ of the transmitter in the 5ₜₕ period. It is worth noting that since the 5ₜₕ period has reached a new report period, the report transmission rate rᵣₑₚ is adjusted according to the residual data amount of the transmitter buffer B_{T} of the 4ₜₕ period. Comparing the playback rate r_{play} of the 7ₜₕ period in the embodiment illustrated in FIG. 7 and the prior art in FIG. 2, they are 139.7 (kb/s) and 150 (kb/s) respectively. Since a report period is 2 seconds, the playback rate r_{play} of the 8ₜₕ period is equal to that of the 7ₜₕ period, as a result, when the residual data amount of receiver buffer B_{R} in FIG. 2 is 0 (kb) in the 8ₜₕ period, which means playback latency has occurred, the residual data amount of receiver buffer B_{R} in the 8ₜₕ period in FIG. 7 is 7.1 (kb), and thus playback latency is improved.

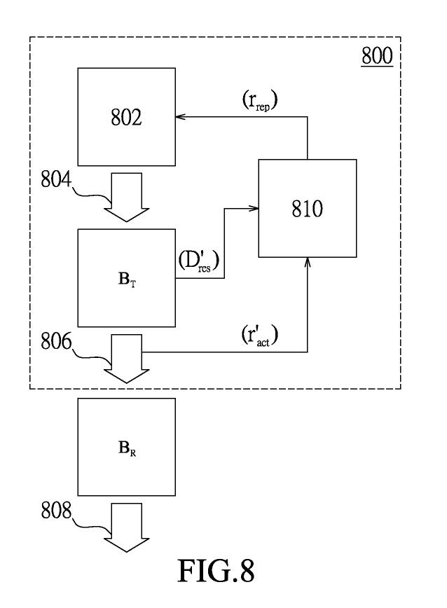

Embodiments of the system architecture realizing the above method are presented below. Referring to FIG. 8, an embodiment of the architecture for controlling transmission of streaming audio/video data 800 is provided. It includes a streaming audio/video data extraction module 802 for extracting a streaming audio/video data from a audio/video data source, and outputting streaming audio/video data at a report transmission rate rᵣₑₚ (denoted by an arrow frame 804); a transmitter buffer B_{T} for accepting streaming audio/video data, and outputting residual data held temporarily and streaming audio/video data at an actual transmission rate r_{act} (denoted by an arrow frame 806); and a transmission amount control module 810 for determining the report transmission rate rᵣₑₚ based on the actual transmission rate r′_{act} and the residual data amount D′ᵣₑₛ, wherein the actual transmission rate r′_{act} and the residual data amount D′ᵣₑₛ are the detected output rate and residual data amount of the transmitter buffer B_{T} respectively (denoted by an arrow sending r′_{act} and another arrow sending D′ᵣₑₛ), and the determined report transmission rate rᵣₑₚ is reported back to streaming audio/video data extraction module 802 (denoted by arrow sending rᵣₑₚ).

Still Referring to FIG. 8, the architecture for controlling transmission of audio/video data 800 operates in a transmitter. Data being output from the transmitter buffer B_{T} travel through a transmission channel and are input to a receiver buffer B_{R} of a receiver at the actual transmission rate r_{act}, and the receiver uses the earlier report transmission rate rᵣₑₚ as the playback rate r_{play} to output data from the receiver buffer B_{R} (denoted by arrow frame 808).

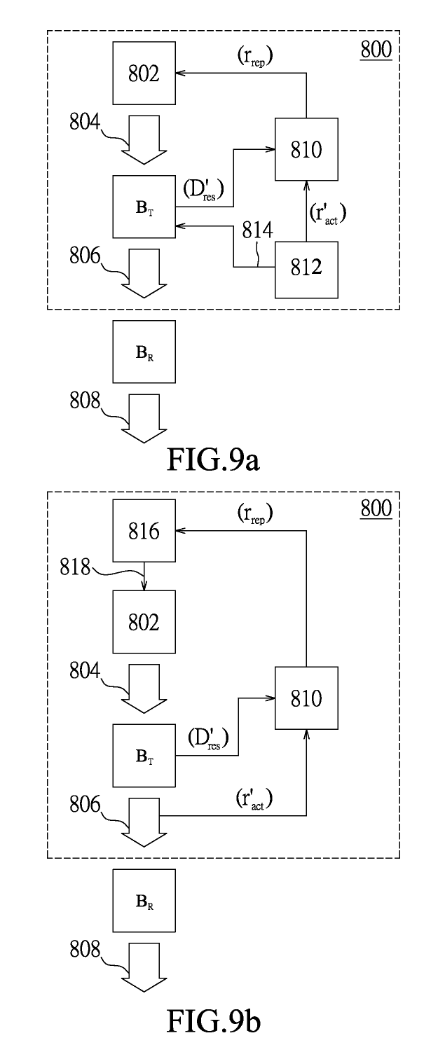

Referring to FIG. 9a, an architecture for controlling transmission of streaming audio/video data according to one embodiment is presented. It extends from the embodiment in FIG. 8, and further includes a media access control (MAC) module 812 for controlling the actual transmission rate r_{act} of the transmitter buffer B_{T} (denoted by arrow 814) and reporting the actual transmission rate r′_{act} to transmission amount control module 810 (denoted by an arrow sending r′_{act}).

Referring to FIG. 9b, an architecture for controlling transmission of streaming audio/video data according to another embodiment is presented. It extends from the embodiment illustrated in FIG. 8, and further includes a streaming audio/video data encoding module 816 for providing the audio/video data source to streaming audio/video data extraction module 802 (denoted by arrow 818). In one embodiment, streaming audio/video data encoding module 816 adopts a Scalable Variable Coding (SVC) scheme.

In summary, a control method of transmitting streaming audio/video data is proposed. On a transmitter, a report transmission rate is determined based on an actual transmission rate, at which data are output from a transmitter buffer, and a residual data amount of the transmitter buffer; on a receiver, the earlier report transmission rate is set to be the playback rate at which data are taken out from the receiver buffer. Since the report transmission rate has been adjusted based on the earlier residual data amount of the transmitter buffer, the number of playback latency occurrences is lowered. Architectures of controlling transmission of streaming audio/video data are also proposed. These architectures mainly include a transmission amount control module for determining the report transmission rate based on the actual transmission rate and the residual data amount of the transmitter buffer, and controlling streaming audio/video data extraction module to transmit the extracted streaming audio/video data to transmitter buffer at the report transmission rate.

The embodiments described above are to demonstrate the technical contents and characteristics of the preset invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A control method of transmitting streaming audio/video data comprising:
determining a report transmission rate based on an actual transmission rate of the previous period and a residual data amount of the previous period of a transmitter buffer for the current period when a new report period has been reached;
inputting an input data amount at said report transmission rate to said transmitter buffer for the current period; and
determining said actual transmission rate based on a required transmission rate and an available transmission rate, and outputting an output data amount from said transmitter buffer at said actual transmission rate for the current period.

2. A control method of transmitting streaming audio/video data according to claim 1, wherein the step of determining said report transmission rate comprises:
estimating an estimated transmission rate based on said actual transmission rate of the current period;
calculating a report transmission rate adjustment based on said residual data amount of the previous period; and
determining said report transmission rate according to said estimated transmission rate and said report transmission rate adjustment.

3. A control method of transmitting streaming audio/video data according to claim 2, wherein said report transmission rate is determined by adjusting said estimated transmission rate up or down according to said report transmission rate adjustment.

4. A control method of transmitting streaming audio/video data according to claim 2, wherein said report transmission rate is determined by subtracting a product of an adjusting coefficient and said report transmission rate adjustment from said estimated transmission rate, wherein said report transmission rate adjustment equals said residual data amount of the pervious period divided by a report period.

5. A control method of transmitting streaming audio/video data according to claim 4, wherein said adjusting coefficient is a fixed or a dynamically adapted value.

6. A control method of transmitting streaming audio/video data according to claim 4 wherein said adjusting coefficient ranges from 0 to 1.

7. A control method of transmitting streaming audio/video data according to claim 2, wherein said report transmission rate is determined by subtracting said report transmission rate adjustment from said estimated transmission rate, and then the result is multiplied by an adjusting coefficient, wherein said report transmission rate adjustment equals said residual data amount of the previous period divided by a report period.

8. A control method of transmitting streaming audio/video data according to claim 6, wherein said adjusting coefficient is a fixed or a dynamically adapted value.

9. A control method of transmitting streaming audio/video data according to claim 6, wherein said adjusting coefficient ranges from 0 to 1.

10. A control method of transmitting streaming audio/video data according to claim 1, wherein the step of determining said actual transmission rate comprises:
determining said required transmission rate based on said residual data amount of a previous period and said input data amount of the current period;
detecting said available transmission rate; and
selecting the minimum between said available transmission rate and said required transmission rate as said actual transmission rate.

11. A control method of transmitting streaming audio/video data according to claim 10 wherein said required transmission rate is determined by adding said residual data amount of the previous period to said input data amount of the current period and dividing the sum by a period.

12. An architecture for controlling transmission of streaming audio/video data, realizing the control method of transmitting streaming audio/video data of claim 1, comprising:
a streaming audio/video data extraction module for extracting streaming audio/video data from an audio/video data source, and outputting said streaming audio/video data at a report transmission rate;
a transmitter buffer for accepting said streaming audio/video data and outputting said streaming audio/video data and residual data pending to be transmitted at an actual transmission rate; and
a transmission amount control module for determining said report transmission rate based on said actual transmission rate and said residual data amount of said transmitter buffer and controlling said streaming audio/video data extraction module to output at said report transmission rate.

13. The architecture for controlling transmission of streaming audio/video data according to claim 12, wherein said transmission amount control module is also capable of detecting said actual transmission rate.

14. The architecture for controlling transmission of streaming audio/video data according to claim 12 further comprising a media access control module for controlling said actual transmission rate, and reporting said actual transmission rate to said transmission amount control module.

15. The architecture for controlling transmission of streaming audio/video data according to claim 12 further comprising a streaming audio/video data encoding module for providing said streaming audio/video data extraction module with said audio/video data source.
